(19) United States
(12) Patent Application Publication
(10) Pub. No.: US 2019/0329569 A1
(43) Pub. Date: Oct. 31, 2019

(54) HIGH SPEED DIGITAL CYLINDER PRINTER

(71) Applicant: James M. Jeter, Jacksonville, FL (US)

(72) Inventor: James M. Jeter, Jacksonville, FL (US)

(21) Appl. No.: 16/394,074

(22) Filed: Apr. 25, 2019

Related U.S. Application Data
(60) Provisional application No. 62/663,375, filed on Apr. 27, 2018.

(51) Int. Cl. B41J 3/407; B41J 2/325

(52) U.S. Cl. CPC B41J 3/4073; B41P 2219/43; B41J 2/325

(57) ABSTRACT

A digital printing system (1) that eliminates the use of printing plates and specially mixed inks, thereby eliminating lost production time caused by the need to change plates as well as cleaning and resupplying inking systems in conventional systems.

### CROSS-REFERENCE TO RELATED APPLICATION

This application claims priority to application No. 62/663,375, filed on Apr. 27, 2018, which is currently pending. The patent application identified above is incorporated herein by reference in its entirety to provide continuity of disclosure.

### FIELD OF THE INVENTION

This invention relates to printing systems for aluminum cans and more particularly a digital cylinder printing system that eliminates the use of printing plates and specially mixed inks.

### BACKGROUND OF THE INVENTION

Conventional printing systems which use offset printing have been used to decorate cylindrical containers, such as aluminum cans, from the early 1900's. These conventional printing systems have the ability to operate in rugged environments and print large volumes of containers extremely quickly. However, conventional printing systems require large amounts of time to change decoration images and inks for new labels, thereby resulting in machine down time during this change-over operation.

Significant financial loss is incurred from the down time required in order to perform printing plate change overs and to correct any flaws. There is also expensive ink waste from color changeover and inking unit clean up. A vast amount of valuable floor space is consumed by storage of the expensive left-over inks until they can be used in a future label run. Labor costs associated with plate fixing, ink mixing, and printing system operation are steadily increasing. New label turn-around time can take weeks, and requires plate making, proof printing, ink trials, and is costly for customers in terms of time to market and associated set up fees.

Therefore, a need exists for a digital printing system that eliminates the use of printing plates and specially mixed inks.

### SUMMARY OF THE INVENTION

The primary object of the present invention is to provide a digital printing system that will eliminate the use of printing plates and specially mixed inks, thereby eliminating the lost production time while plates are changed and inking systems are cleaned and resupplied.

An additional object of the present invention is to provide a digital printing system that eliminates the use of custom mixed ink to a nearly infinite color gamut using the WCMYK printing process.

An additional object of the present invention is to provide a digital printing system that can be used to produce smaller production runs without incurring the conventional costs associated with changing over plates and inks for new production runs.

An additional object of the present invention is to provide a digital printing system that solves the following problems faced with when using conventional digital packaging printing:
Conventional ink is typically UV energy cured and is not food safe;
Conventional ink is thick and expensive;
Conventional digital printing processes are indexing and are too slow;
Conventional electrostatic printing systems are susceptible to dust contamination and are slow; and
Conventional piezoelectric print heads are prone to nozzle failure and are slow compared to current processes.

The present invention fulfills the above and other objects by providing a digital cylinder printing system that uses a continuous motion container handler to move each cylinder through an individual color station, which includes (WCMYK, Spot, Clear, etc.), where it is printed with variable data produced from a color separated image from each label.

The above and other objects, features and advantages of the present invention should become even more readily apparent to those skilled in the art upon a reading of the following detailed description in conjunction with the drawings wherein there is shown and described illustrative embodiments of the invention.

### BRIEF DESCRIPTION OF THE DRAWINGS

In the following detailed description, reference will be made to the attached drawings in which:

FIG. 1 is a side view of a servo motor controlled rotary support mandrel of the present invention;

FIG. 2. is a front view of a servo motor controlled rotary support mandrel of the present invention;

FIG. 3 is a sectional side view along lines A-A of FIG. 2 of a servo motor controlled rotary support mandrel of the present invention;

FIG. 4 is a side view of a rail guide mounting assembly supported by a common disc assembly mounted to a main shaft assembly;

FIG. 5 is a magnified view along lines B-B of FIG. 4 of a guide rail mounting system of the present invention; and

FIG. 6 is a front view of a radial array of mandrel supports of the present invention.

### DESCRIPTION OF THE PREFERRED EMBODIMENTS

For purposes of describing the preferred embodiment, the terminology used in reference to the numbered accessories in the drawings is as follows:
1. digital cylinder printing system, generally
2. rail guide mounting assembly
3. mandrel
4. mandrel servo motor
5. color station
6. white color station
7. cyan color station
8. magenta color station
9. yellow color station
10. black color station
11. spot station
12. clear station
13. mandrel support block
14. mandrel trip mechanism
15. disc assembly
16. main shaft assembly
17. support shaft servo motor
18. front cam follower
19. rear cam follower
20. front cam track
21. rear cam track
22. support frame
23. blanket roller
24. transfer roller
25. metering roller
26. doctor roller

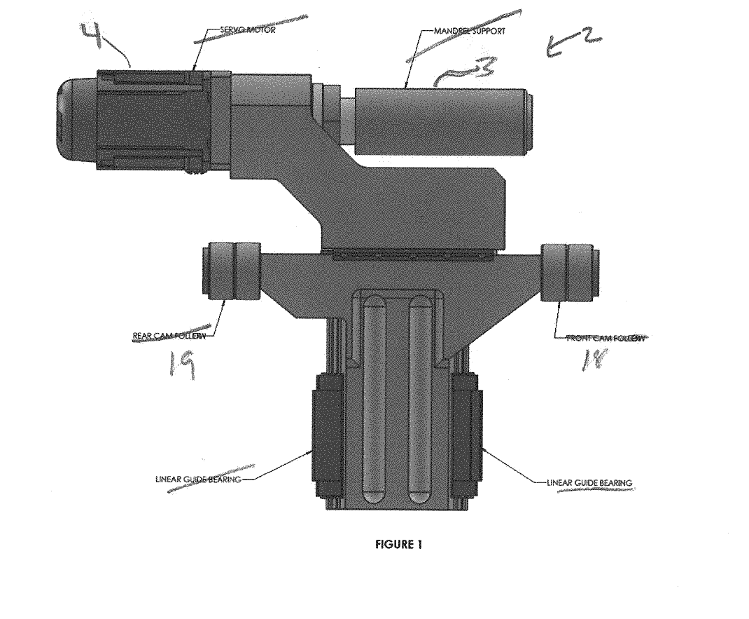

The digital cylinder printing system 1 of the present invention comprises a continuous motion container handler to move each cylindrically-shaped container having an image printed thereon through a series of color stations 5, as illustrated in FIG. 6, comprising a white color station 6, a cyan color station 7, a magenta color station 8, a yellow color station 9, a black color station 10, a spot station 11, a clear station 12 and so forth. Each cylinder, is moved through the color station 5 on a mandrel 3 supported by a rail guide mounting assembly 2, as illustrated in FIGS. 1-3, wherein at least one image is printed on each cylindrically-shaped container using variable data produced from a color separated image from each label.

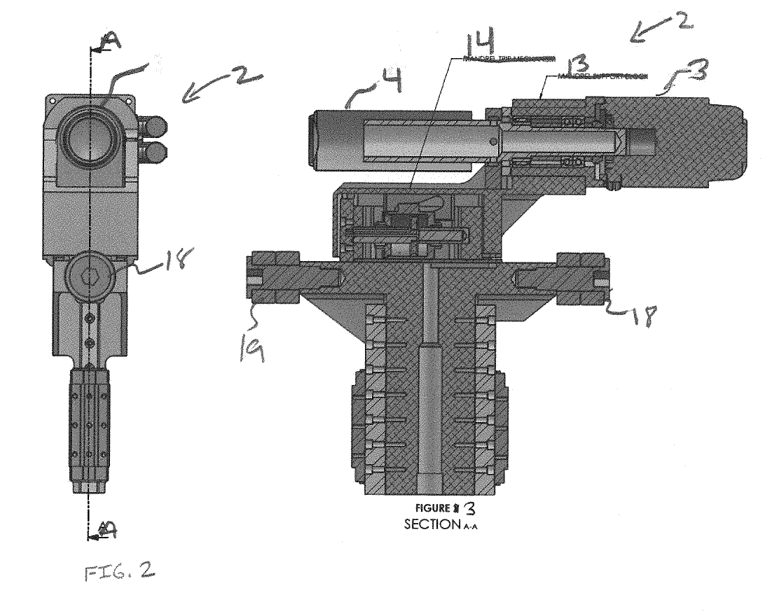

With reference to FIG. 1-3, a side view, front view and sectional side view along lines A-A of FIG. 2, respectively, of a rail guide mounting assembly 2 supporting a rotary mandrel 3 controlled by a mandrel servo motor 4 is illustrated. Cylindrical containers are loaded onto the mandrel 3, which is rotated by the servo motor 4 as the rail guide mounting assembly 2 is moved through the series of color stations 5.

The mandrel 3 is rotated in synchronized motion as it is rolled around a controlled blanket roller containing an inked image that is transferred onto a container on the mandrel 3. This synchronized motion is preferably accomplished using at least one electronic gearing component located in a programmable logic controller (PLC) in communication with the mandrel servo motor 4.

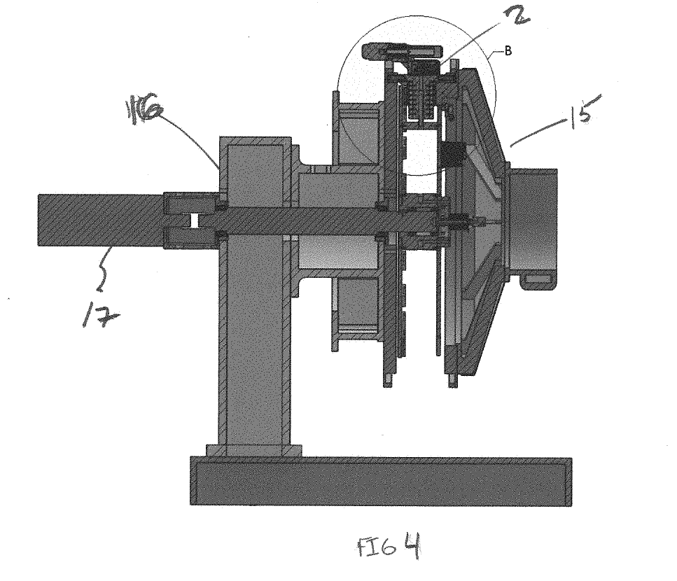

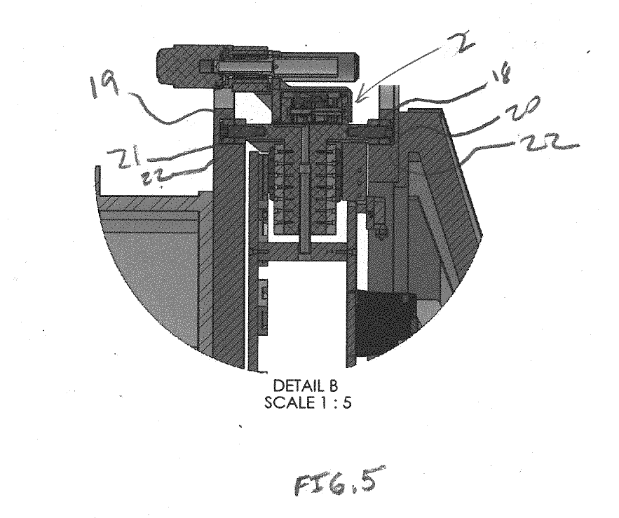

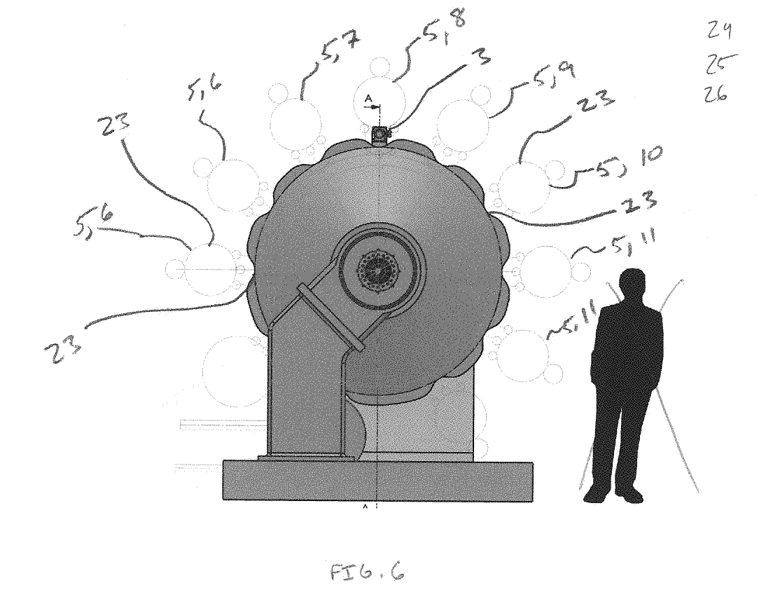

The mandrel 3 is supported by a mandrel support block 13 containing a mandrel trip mechanism 14, as illustrated in FIG. 3. Each mandrel support block 13 is guided by a linear bearing rail guide mounting assembly 2, as illustrated in FIGS. 4 and 5.

With reference to FIGS. 4 and 5, a side view of a rail guide mounting assembly 2 is supported by a common disc assembly 15 mounted to a main shaft assembly 16 and a magnified view along lines B-B of FIG. 4 of a guide rail mounting system 2 of the present invention, respectively, are illustrated. Each rail guide mounting assembly 2 is supported by a common disc assembly 15 mounted to a main shaft assembly 16. The common disc assembly 15 rotates about the main support shaft assembly 16 which is driven by a support shaft servo motor 17 that is in communication with each mandrel 3 and any corresponding blanket roller motor.

As illustrated in FIG. 1, each rail guide mounting assembly 2 comprises a front cam follower 18 and a rear cam follower 19 which engage a front grooved cam track 20 and a rear grooved cam track 21, respectively. The front cam follower 18 and the rear cam follower 19 are positioned on rigid supports frame 22 which provide precise phase timing, registration, and concentric positioning, relative to the main support shaft 17.

As illustrated in FIG. 5. the front cam follower 18 and the rear cam follower 19 are designed with a series of curved profiles 23, which correspond to each of the different color stations 5. As the radial array of mandrels 3 are rotated by support shaft servo motor 17, the front cam follower 18 and the rear cam follower 19 will follow the curved profiles 23 to cause the mandrels 3 to move reciprocally relative to the main shaft assembly 16 and the resultant motion will cause each mandrel 3 to “track” around each blanket roller 23. Each can mandrel 3 is individually controlled to maintain precise registration to each of the different color station 5 blanket rollers 23 using specially derived computer programming and communication protocol.

Electrophotography, the printing technology adapted to this machine is derived from the electro photographic process or xerography. Each color station applies a single color only, replicating the four process color procedure, with the addition of White and pantones. Therefore, the color stations 5 comprise Cyan, Magenta, Yellow, Black, and finally a Clear overprint varnish plus additional specific colors if desired. In addition, each color station 5 preferably comprises a blanket roller 23, transfer roller 24, metering roller 25, and a doctor roller 26. Liquid toner or ink is supplied and circulated to each color station 5 ink fountain from a common ink management system.

Each color station 5 may further comprise a photoreceptor roller and an LED array called a write head, an electrostatic charge head, or corotron, a cleaning station and toner recovery system.

A liquid carrier in the ink is preferably an Isopar variant and is evaporated from a pigment in or after each color station 5 so a particular image is dry before reaching a subsequent color station 5.

The mandrels 3 are charged either negative or positive, depending on the charge selected for the transfer roller 24 and pigment, to aid in the attraction of the pigmented image to a cylinder surface. The cylinder surface cylinder surface may or may not come into contact with the blanket roller 23 to facilitate the transfer of the image.

It is to be understood that while a preferred embodiment of the invention is illustrated, it is not to be limited to the specific form or arrangement of parts herein described and shown. It will be apparent to those skilled in the art that various changes may be made without departing from the scope of the invention and the invention is not to be considered limited to what is shown and described in the specification and drawings.

Having thus described my invention, I claim:

1. A digital cylinder printing system comprising:
a continuous motion container handler to move each cylindrically-shaped container having an image printed thereon through a series of color stations via a mandrel supported by a rail guide assembly; and
said image being printed on said container via electrophotography wherein said series of color stations comprises a white color station, a cyan color station, a magenta color station, a yellow color station, a black color station, a spot station and a clear station.

2. The digital cylinder printing system of claim 1 further comprising:
a rail guide mounting assembly supporting said mandrel and a mandrel servo motor that rotates said mandrel as the rail guide mounting assembly is moved through the series of color stations.

3. The digital cylinder printing system of claim 1 wherein:
said mandrel is supported by a mandrel support block containing a mandrel trip mechanism.

4. The digital cylinder printing system of claim 3 wherein:
each mandrel support block is guided by a linear bearing rail guide mounting assembly supported by a common disc assembly mounted to a main shaft assembly.

5. The digital cylinder printing system of claim 4 wherein:
said common disc assembly rotates about the main support shaft assembly which is driven by a support shaft servo motor.

6. The digital cylinder printing system of claim 1 wherein:
at least one image is printed on said container using variable data produced from a color separated image.

7. The digital cylinder printing system of claim 2 wherein:
said rail guide mounting assembly comprises a front cam follower and a rear cam follower which engage a front grooved cam track and a rear grooved cam track, respectively.

8. The digital cylinder printing system of claim 7 wherein:
said front cam follower and rear cam follower have a series of curved profiles which correspond to each color station.

9. A digital cylinder printing system comprising:
a continuous motion container handler to move each cylindrically-shaped container having an image printed thereon through a series of color stations via a mandrel supported by a rail guide assembly;
said image being printed on said container via electrophotography wherein said series of color stations comprises a white color station, a cyan color station, a magenta color station, a yellow color station, a black color station, a spot station and a clear station; and
a rail guide mounting assembly supporting said mandrel and a mandrel servo motor that rotates said mandrel as the rail guide mounting assembly is moved through the series of color stations.

10. The digital cylinder printing system of claim 9 wherein:
said mandrel is supported by a mandrel support block containing a mandrel trip mechanism.

11. The digital cylinder printing system of claim 10 wherein:
each mandrel support block is guided by a linear bearing rail guide mounting assembly supported by a common disc assembly mounted to a main shaft assembly.

12. The digital cylinder printing system of claim 11 wherein:
said common disc assembly rotates about the main support shaft assembly which is driven by a support shaft servo motor.

13. The digital cylinder printing system of claim 9 wherein:
at least one image is printed on said container using variable data produced from a color separated image.

14. The digital cylinder printing system of claim 9 wherein:
said rail guide mounting assembly comprises a front cam follower and a rear cam follower which engage a front grooved cam track and a rear grooved cam track, respectively.

15. The digital cylinder printing system of claim 14 wherein:
said front cam follower and rear cam follower having a series of curved profiles which correspond to each color station.

16. A digital cylinder printing system comprising:
a continuous motion container handler to move each cylindrically-shaped container having an image printed thereon through a series of color stations via a mandrel supported by a rail guide assembly;
said image being printed on said container via electrophotography wherein said series of color stations comprises a white color station, a cyan color station, a magenta color station, a yellow color station, a black color station, a spot station and a clear station;
a rail guide mounting assembly supporting said mandrel and a mandrel servo motor that rotates said mandrel as the rail guide mounting assembly is moved through the series of color stations;
said mandrel is supported by a mandrel support block containing a mandrel trip mechanism; and
each mandrel support block is guided by a linear bearing rail guide mounting assembly supported by a common disc assembly mounted to a main shaft assembly.

17. The digital cylinder printing system of claim 16 wherein:
said common disc assembly rotates about the main support shaft assembly which is driven by a support shaft servo motor.

18. The digital cylinder printing system of claim 16 wherein:
at least one image is printed on said container using variable data produced from a color separated image.

19. The digital cylinder printing system of claim 16 wherein:
said rail guide mounting assembly comprises a front cam follower and a rear cam follower which engage a front grooved cam track and a rear grooved cam track, respectively.

20. The digital cylinder printing system of claim 19 wherein:
said front cam follower and rear cam follower have a series of curved profiles which correspond to each color station.
